(19) United States
(12) Patent Application Publication
(10) Pub. No.: US 2013/0311248 A1
(43) Pub. Date: Nov. 21, 2013

(54) METHODS AND APPARATUS FOR INCENTIVIZING ACTIONS ASSOCIATED WITH USE OF A NFC BASED PAYMENT FORM

(71) Applicants: Damir Didjusto, San Diego, CA (US); Shriram Ganesh, San Diego, CA (US)

(72) Inventors: Damir Didjusto, San Diego, CA (US); Shriram Ganesh, San Diego, CA (US)

(73) Assignee: QUALCOMM Incorporated, San Diego, CA (US)

(21) Appl. No.: 13/473,889

(22) Filed: May 17, 2012

(51) Int. Cl. G06Q 30/02; H04B 5/00

(52) U.S. Cl. 705/14.1

(57) ABSTRACT

Aspects disclosed herein relate to providing an incentive structure associated with various actions that are tied to access and/or use of a NFC based payment form. In one example, a NFC device may be configured to determine that a usage value for a NFC device is within a threshold value of a NFC account ceiling value. The NFC device may be further configured to provide a user with one or more actions to perform and information indicating how each of the one or more actions will affect the NFC account ceiling value.

### BACKGROUND

1. Field

The disclosed aspects relate generally to communications between and/or within devices and specifically to methods and systems for providing an incentive structure associated with various actions that are tied to access and/or use of a near field communication (NFC) based payment form.

2. Background

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Many such cellular telephones are manufactured with ever increasing computing capabilities, and as such, are becoming tantamount to small personal computers and hand-held PDAs. Further, such devices are enabling communications using a variety of frequencies and applicable coverage areas, such as cellular communications, wireless local area network (WLAN) communications, NFC, etc.

Currently, when a user performs a payment for goods or a service there is no way for the form of payment (cash or credit card) to affect how the money is being spent. For example, no internal attributes of currently available payment forms (e.g., cash, credit cards, bitcoins, etc.), allow the payment form to influence upon what it is being spent and/or when it is being spent. As such, there is currently no way to implement an inventive structure to reward/penalize a user for various actions tied to access and/or use of a payment form.

Thus, improved apparatuses and methods providing an incentive structure associated with various actions that are tied to access and/or use of a NFC based payment form may be desired.

### SUMMARY

The following presents a summary of one or more aspects to provide a basic understanding of such aspects. This summary is not an extensive overview of all contemplated aspects, and is not intended to identify key or critical elements of all aspects nor delineate the scope of any or all aspects. Its purpose is to present some concepts of one or more aspects form as a prelude to the more detailed description presented later.

Various aspects are described in connection with providing an incentive structure associated with various actions that are tied to access and/or use of a NFC based payment form. In one example, a NFC device may be configured to determine that a usage value for a NFC device is within a threshold value of a NFC account ceiling value. The NFC device may be further configured to provide a user with one or more actions to perform and information indicating how each of the one or more actions will affect the NFC account ceiling value.

According to related aspects, a method provides a mechanism for incentivizing actions associated with use of a NFC based payment form. The method can include determining that a usage value for a NFC device is within a threshold value of a NFC account ceiling value. Further, the method can include providing a user with one or more actions to perform and information indicating how each of the one or more actions will affect the NFC account ceiling value.

Another aspect relates to an activity module associated with a communications apparatus. The activity module can include means for determining that a usage value for a NFC device is within a threshold value of a NFC account ceiling value. Further, the activity module can include means for providing a user with one or more actions to perform and information indicating how each of the one or more actions will affect the NFC account ceiling value.

Another aspect relates to a communications apparatus. The apparatus can include an activity module configured to determine that a usage value for a NFC device is within a threshold value of a NFC account ceiling value. The activity module may also be configured to provide a user with one or more actions to perform and information indicating how each of the one or more actions will affect the NFC account ceiling value.

Another aspect relates to a computer program product, which can have a computer-readable medium comprising code for determining that a usage value for a NFC device is within a threshold value of a NFC account ceiling value. The computer-readable medium can also include code for providing a user with one or more actions to perform and information indicating how each of the one or more actions will affect the NFC account ceiling value.

To the accomplishment of the foregoing and related ends, the one or more aspects comprise features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a wireless communication system, according to an aspect.

FIG. 2 is a schematic diagram of a wireless communication system, according to an aspect.

FIG. 3 is a block diagram of a NFC environment, according to an aspect;

FIG. 4 is a block diagram of a NFC environment at various times, according to an aspect;

FIG. 5 is a flowchart describing an example of an NFC device to perform incentivizing actions associated with use of a NFC based payment form, according to an aspect;

FIG. 6 is a flowchart describing another example of an NFC device to perform incentivizing actions associated with use of a NFC based payment form, according to an aspect;

FIG. 7 illustrates a functional block diagram of an example architecture of a communications device, according to an aspect; and

FIG. 8 illustrates a block diagram of an example communication system for performing incentivizing actions associated with use of a NFC based payment form, according to an aspect.

### DETAILED DESCRIPTION

Various aspects are now described with reference to the drawings. In the following description, for purposes of explanation, numerous specific details are set forth to provide a thorough understanding of one or more aspects. It should be understood, however, that such aspect(s) may be practiced without these specific details.

Generally, a device may recognize a NFC target device and/or tag when within range of the coverage area of the NFC device and/or tag. Thereafter, the NFC device may obtain communication with the NFC target device. In an aspect, NFC communications may be used to perform payment for goods and/or services. Further, an NFC device may be configured with various sensors, applications, etc., that may be monitored and/or analyzed. As described herein, use and/or access to a NFC based payment form may be incentivized based on monitored and/or analyzed actions associated with the various sensors, applications, etc.

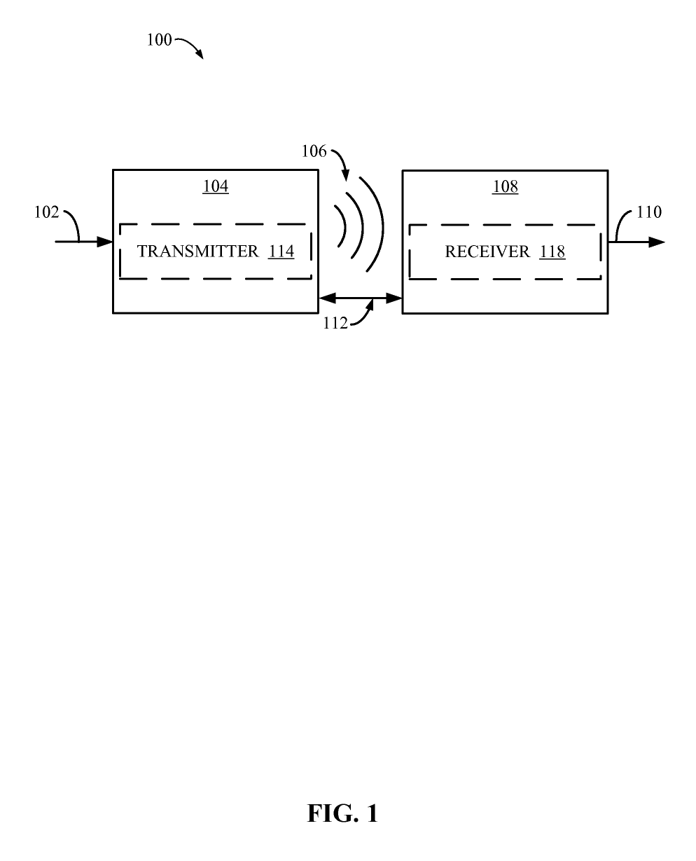

FIG. 1 illustrates a wireless communication system 100, in accordance with various exemplary embodiments of the present invention. Input power 102 is provided to a transmitter 104 for generating a radiated field 106 for providing energy transfer. A receiver 108 couples to the radiated field 106 and generates an output power 110 for storing or consumption by a device (not shown) coupled to the output power 110. Both the transmitter 104 and the receiver 108 are separated by a distance 112. In an exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the radiated field 106.

Transmitter 104 further includes a transmit antenna 114 for providing a means for energy transmission. A receiver 108 includes a receive antenna 118 as a means for energy reception. The transmit and receive antennas are sized according to applications and devices associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

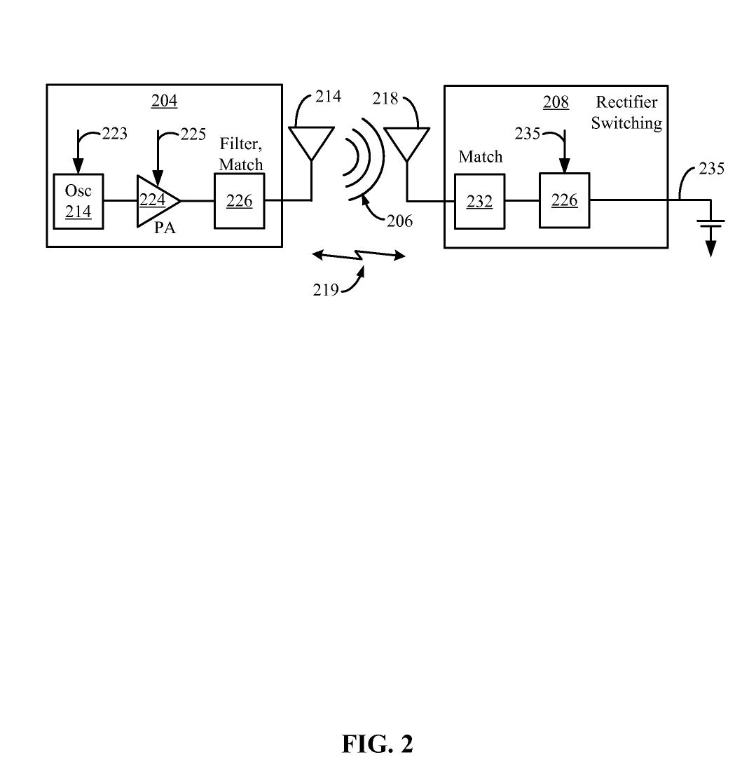

FIG. 2 is a schematic diagram of an example near field wireless communication system. The transmitter 204 includes an oscillator 222, a power amplifier 224 and a filter and matching circuit 226. The oscillator is configured to generate a signal at a desired frequency, which may be adjusted in response to adjustment signal 223. The oscillator signal may be amplified by the power amplifier 224 with an amplification amount responsive to control signal 225. The filter and matching circuit 226 may be included to filter out harmonics or other unwanted frequencies and match the impedance of the transmitter 204 to the transmit antenna 214.

The receiver 208 may include a matching circuit 232 and a rectifier and switching circuit 234 to generate a DC power output to charge a battery 236 as shown in FIG. 2 or power a device coupled to the receiver (not shown). The matching circuit 232 may be included to match the impedance of the receiver 208 to the receive antenna 218. The receiver 208 and transmitter 204 may communicate on a separate communication channel 219 (e.g., Bluetooth, zigbee, cellular, etc).

The receiver 208 may include a matching circuit 232 and a rectifier and switching circuit 234 to generate a DC power output to charge a battery 236 as shown in FIG. 2 or power a device coupled to the receiver (not shown). The matching circuit 232 may be included to match the impedance of the receiver 208 to the receive antenna 218. The receiver 208 and transmitter 204 may communicate on a separate communication channel 119 (e.g., Bluetooth, zigbee, cellular, etc).

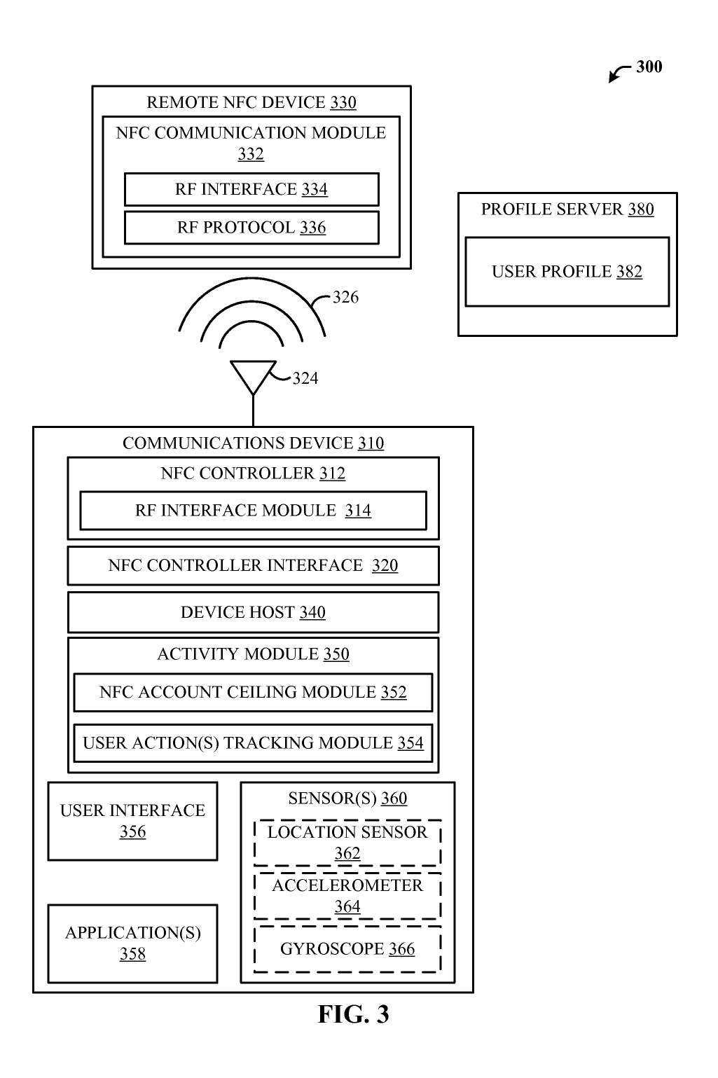

With reference to FIG. 3, a block diagram of a communication network 300 according to an aspect is illustrated. Communication network 300 may include communications devices 310 which, through antenna 324, may be in communication with a remote NFC device 330 using one or more NFC technologies 326 (e.g., NFC-A, NFC-B, NFC-F, etc.). In an aspect, remote NFC device 330 and/or communications device 310 may be operable to communicate through NFC communication module 332 through one or more RF interfaces 334 using one or more RF protocols 336. In another aspect, communications device 310 may be operable to be connected to an access network and/or core network (e.g., a CDMA network, a GPRS network, a UMTS network, and other types of wireline and wireless communication networks). In an aspect, communications device 310 may further be in communication with profile server 380. In such an aspect, profile server 380 may include a user profile 382 that may include information associated with a user, such as but not limited to, NFC account ceiling value(s), history information associated with actions performed by the user, information associated with one or more funding sources (e.g., credit card account information, bank account information, etc.). In another aspect, remote NFC device 330 may include but is not limited to a remote NFC tag, a reader/writer device, a peer initiator device, a remote peer target device, a card emulator, etc.

Communications device 310 may include NCI 320. In an aspect, NCI 320 may be operable to enable communications between a NFC enabled antenna 324 and NFC controller 312.

Communications device 310 may include a NFC controller (NFCC) 312. In an aspect, NFCC 312 may include RF interface module 314. RF interface module 314 may be operable to enable NFC based communications. DH 340 may be operable to generate a command to prompt NFCC 312 to perform various functions associated with enabling NFC based communications.

Communications device 310 may include activity module 350. Activity module 350 may include one or more NFC account ceiling values 352, and a user action tracking module 354. Further, activity module 350 may be operable to determine that a usage value is within a threshold value of a NFC account ceiling value 352, and may providing a user with one or more actions to perform and information indicating how each of the one or more actions will affect the NFC account ceiling value 352. In an aspect, activity module 350 may obtain the NFC account ceiling value from a user interface 356. In an aspect, user action tracking module 354 may detect that the user has performed an action based on one or more informational values such as a measurement from detected from a user interface 356, one or more sensors 360, one or more applications 358, etc. In an aspect, the sensors 360 may optionally include any combination of a location sensor 362, an accelerometer 364, a gyroscope 366, a light sensor, one or more hardware components, one or more software components, one or more firmware components, etc. In an aspect, the actions may be associated with one or more applications 358 on the communications device 310. For example, an action may include a number of pages read, time spend reading, etc., using an e-reader application 358. In another example, an action may include a distance, a number of calories, a time, etc. associated with use of a sport activity tracking application 358. In another example, an action may include checking in at a location (e.g., a gym, a library, a school, etc.) based on measurements obtained from one or more sensors (e.g., a location sensor 362). In an aspect, activity module 350 may be operable to modifying the NFC account ceiling value 352 based on information user action tracking module 354 may provide indicating how the action will affect the NFC account ceiling value 352. Further, activity module 350 may prohibit the communications device 310 from performing the determined NFC action upon a determination that the user is attempting to perform a NFC action that will result in the NFC account ceiling value 352 being exceeded.

Accordingly, a system and method is disclosed to provide an incentive structure associated with various actions that are tied to access and/or use of a NFC based payment form.

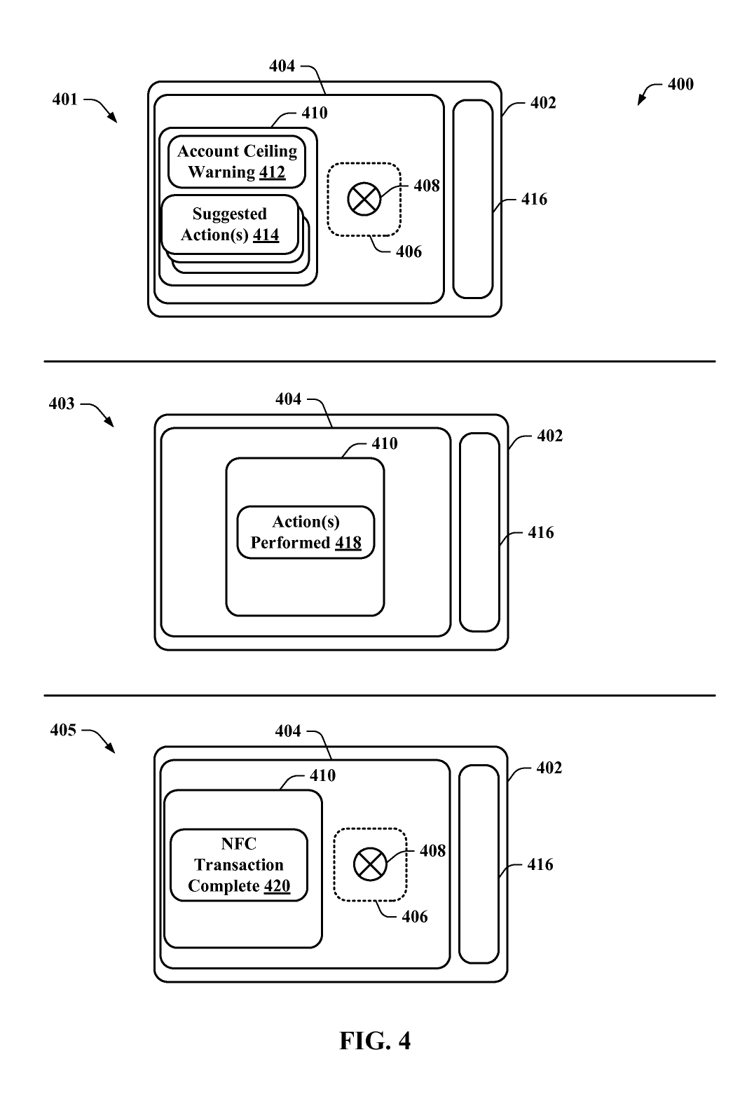

FIG. 4 is a block diagram of a NFC communications environment 400 at various times (401, 403, 405), according to an aspect.

Communications environment 400 may include a communications device 402 operable to perform NFC communications with an remote NFC endpoint 406. In the depicted aspect, communications device 402 may include a user interface 404, an NFC module 408, and one or more applications/sensors 416. In an aspect, the remote NFC endpoints 406 may include, but are not limited to, a remote NFC tag, a reader/writer device, a peer initiator device, a remote peer target device, a card emulator, etc.

At time 401, NFC module 408 associated with communications device 402 may be placed within proximity of remote NFC endpoint 406. In an aspect, such placement may be performed to establish an NFC link for the purpose of providing a payment. In such an aspect, NFC module 408 may be coupled to one or more applications providing funding for the attempted payment. Further, NFC module 408 may be associated with an activity module 410. Activity module 410 may include one or more NFC account ceiling values and may provide a accounting ceiling warning 412 a user with one or more actions 414 to perform and information indicating how each of the one or more actions will affect the NFC account ceiling value.

At time 403, activity module 410 may detect that one or more of actions have been performed 418. In an aspect, the actions performed 418 may be one or more of the suggested actions 414. In another aspect, activity module 410 may detect that the one or more actions have been performed based on information obtained from the application(s)/sensor(s) 416. In response to the performance of the actions 418, activity module 410 may modify at least one of the NFC account ceiling values.

At time 405, the communications device 402 may be placed within proximity of remote NFC endpoint 406 to establish an NFC link. In an aspect, the NFC link may be used to attempt to purchase goods, services, etc. In the depicted aspect, since the user performed one or more actions 418 at time 403 which modified the NFC account ceiling, the attempted transaction may be successfully completed 420.

Accordingly, an example communications environment 400 is disclosed in which a communications device 402 may use a NFC module 408 and an activity module 410 to incentivize various actions by coupling the performance or nonperformance of the actions with access and/or use of a NFC based payment form.

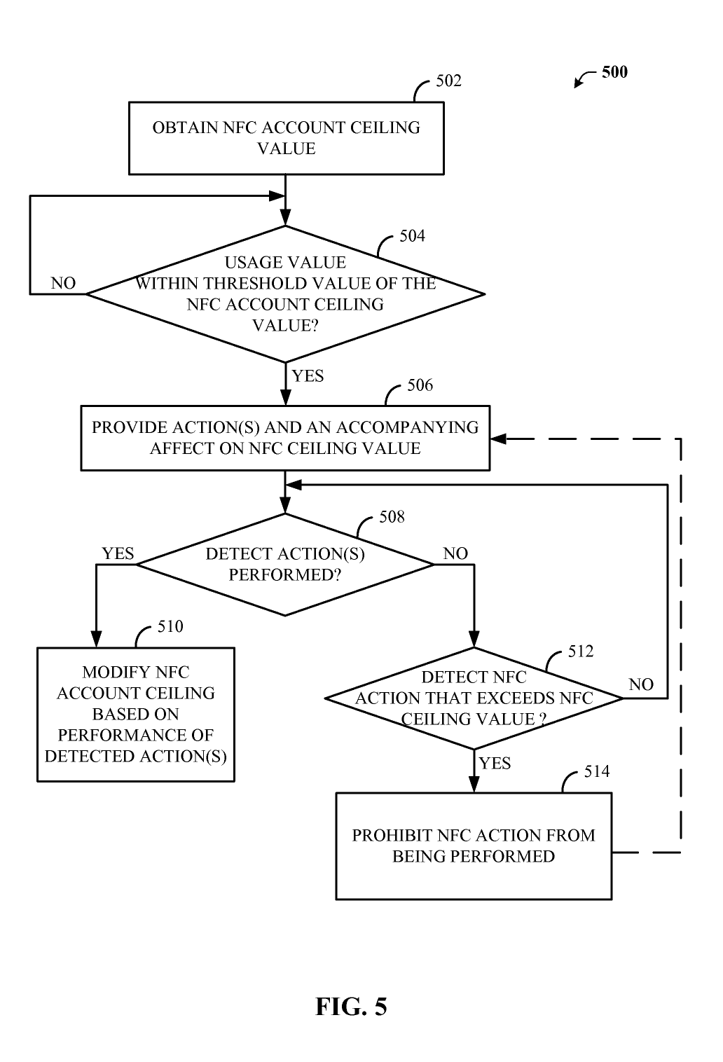

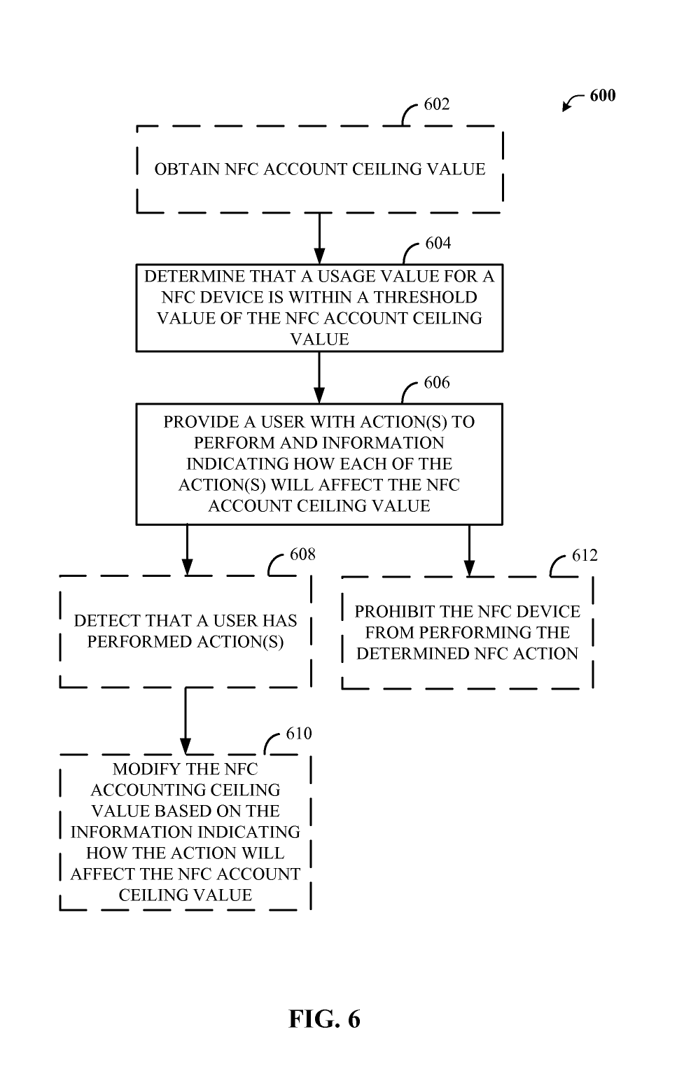

FIGS. 5 and 6 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 5 illustrates an example flowchart process 500 for a NFC enabled device to influence use and/or access to an NFC payment process based on one or more user actions.

At block 502, a NFC device may obtain an NFC account ceiling value. In one aspect, the NFC account ceiling value may be a budget that has been defined by a user for purchase of various goods or services. In one aspect, the NFC account ceiling may be a single limit value for purchases using the NFC device (e.g., a device based allowance). In another aspect, the NFC ceiling may include values associated with different types of purchases (e.g., a fast food budget, a clothing budget, etc.).

At block 504, the UE may determine whether activity/usage of the NFC device results in a user usage value being within a threshold value of the NFC account ceiling value. In one aspect, the threshold value may be a set value such as a set monetary amount (e.g., within 10 dollars of the ceiling value). In another aspect, the threshold value may be a percentage (e.g., within 10% of the NFC account ceiling).

If at block 504, the NFC device determines that the usage has not resulted in the usage within the threshold of the NFC account ceiling, then the NFC device may continue to monitor the user's usage/spending.

By contrast, if at block 504, the NFC device determines that the usage has resulted in the user usage value being within the threshold value of the NFC account ceiling, then at block 506, the NFC device may provide one or more actions that a user may perform and have each of the one or more actions may affect the NFC ceiling. For example, a user may have budgeted $20 for fast food, and the user has already spent $19. In the example aspect, NFC device may alert the user and provide him with an activity indicating that if the user runs 1 mile, then the NFC account ceiling may be raised by $5 and/or for 2 miles the NFC account ceiling may be raise by $10. In another example aspect, a user may indicate that for each of 10 pages read, the NFC account ceiling may be increased by 5 bitcoins.

At block 508, the NFC device determines whether one or more of the one or more provided actions has been performed by the user. In one aspect, the NFC device may have access to information obtained from other applications, sensors, etc., available through the NFC device and/or through a server storing information associated with the user. For example, an exercise tracking application and/or a GPS sensor may be used to track distance traveled by a user and optionally the speed at which the user was traveling. In another aspect, an e-book application may be queried to determine a number of pages read by a user.

If at block 508, the NFC device determines that a provided action has been performed, then at block 510, the NFC device may modify the NFC account ceiling value. In one aspect, the action may positively or negatively affect the value of the NFC ceiling. For example, 5 dollars may be added to the fast food budget when the NFC device determines that the user has run a mile and/or 5 dollars may be removed from the fast food budget when the NFC device detects that the user has not performed any exercise over the previous week.

By contrast, if at block 508, the NFC device determines that none of the provided actions have been performed, then at block 512 the NFC device may determine whether an attempted NFC action will result in the NFC account ceiling value being exceeded.

If at block 512, the NFC device determines that the attempted NFC action will result in the NFC account ceiling value being exceeded, then at block 514 the NFC may prohibit the NFC action from being performed and optionally may return to block 506 to reiterate one or more actions that may affect the NFC account ceiling value.

If at block 512, the NFC device determines that attempted NFC action will not result in the NFC account ceiling value being exceeded, then the process may result to block 508.

As such, a process is disclosed in which a NFC device may provide an inventive structure to reward a user for various actions that is tied to access and use of a payment form.

FIG. 6 is an example process 600 for incentivizing actions associated with use of a NFC based payment form.

In an optional aspect, at block 602, a device may obtain an NFC account ceiling value. In an aspect, the NFC account ceiling value may includes one or more ceiling values associated with one or more types of NFC enabled actions. In another aspect, the NFC account ceiling value may be associated with funding available through one or more accounts associated with the user. In such an aspect, the accounts may include a credit card account, a bank account, etc.

At block 604, a NFC device may determine that a usage value is within a threshold value of the NFC account ceiling value. In an aspect, the NGC device may further determine that a user's action may result in the NFC account ceiling value being exceeded.

At block 606, the device may provide a user with one or more actions to perform and information indicating how each of the one or more actions will affect the NFC account ceiling value. In an aspect, the actions may be associated with one or more applications on the NFC device. For example, an action may include a number of pages read, time spend reading, etc., using an e-reader application. In another example, an action may include a distance, a number of calories, a time, etc. associated with use of a sport activity tracking application. In another example, an action may include checking in at a location (e.g., a gym, a library, a school, etc.) based on measurements obtained from one or more sensors (e.g., a GPS monitor).

In an optional aspect, at block 608, the NFC device may detect that the user has performed at least one of the one or more actions. In such an optional aspect, at block 610, the NFC device may modify the NFC account ceiling value based on the information indicating how the action will affect the NFC account ceiling value. Further, the modification of the NFC account ceiling may result in more or less funding being made available to the user. For example, completion of a number of pages (based on information made available by an e-reader application) may raise the NFC account ceiling value. In another example, where a NFC device determines that a user has not checked-in at a library during a defined afterschool window, the NFC account ceiling value may be decreased.

In another optional aspect, where the NFC device determines that the user has not completed a suggested action and/or is attempting to perform a NFC action that will result in the NFC account ceiling value being exceeded, at block 612, the NFC device may prohibit the determined NFC action from being performed.

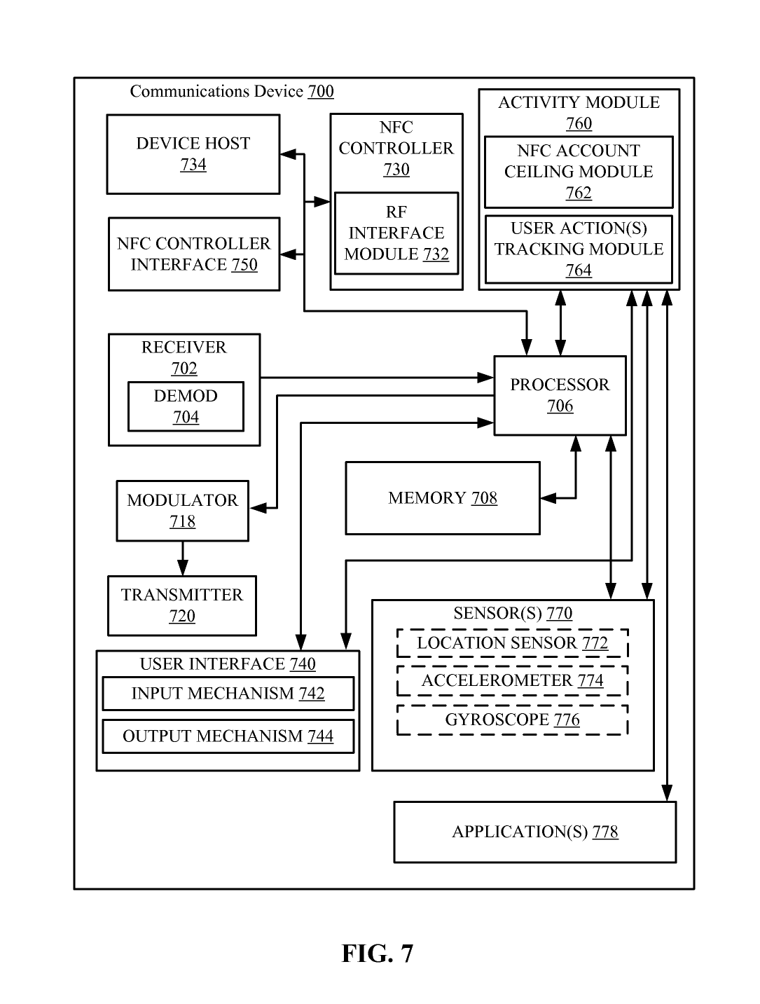

While referencing FIG. 3, but turning also now to FIG. 7, an example architecture of communications device 700 is illustrated. As depicted in FIG. 7, communications device 700 comprises receiver 702 that receives a signal from, for instance, a receive antenna (not shown), performs typical actions on (e.g., filters, amplifies, downconverts, etc.) the received signal, and digitizes the conditioned signal to obtain samples. Receiver 702 can comprise a demodulator 704 that can demodulate received symbols and provide them to processor 706 for channel estimation. Processor 706 can be a processor dedicated to analyzing information received by receiver 702 and/or generating information for transmission by transmitter 720, a processor that controls one or more components of communications device 700, and/or a processor that both analyzes information received by receiver 702, generates information for transmission by transmitter 720, and controls one or more components of communications device 700. Further, signals may be prepared for transmission by transmitter 720 through modulator 718 which may modulate the signals processed by processor 706.

Communications device 700 can additionally comprise memory 708 that is operatively coupled to various components, such as but not limited processor 706 and that can store data to be transmitted, received data, information related to available channels, TCP flows, data associated with analyzed signal and/or interference strength, information related to an assigned channel, power, rate, or the like, and any other suitable information for assisting in NFC connection establishment.

Further, processor 706, and/or activity module 760 can provide means for determining that a usage value for the communications device 700 is within a threshold value of a NFC account ceiling value, and means for providing a user with one or more actions to perform and information indicating how each of the one or more actions will affect the NFC account ceiling value.

It will be appreciated that data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods may comprise, without being limited to, these and any other suitable types of memory.

Communications device 700 may include a NFC controller 730. In an aspect, NFCC 730 may include RF interface module 732. RF interface module 732 may be operable to enable NFC communications.

In another aspect, communications device 700 may include NCI 750. In an aspect, NCI 750 may be operable to enable communications between a NFC enabled antenna (e.g., 702, 720), NFC controller 730 and device host 734. NCI 750 may be operable to function in a listening mode and/or a polling mode.

In another aspect, communications device 700 may include activity module 760. Activity module 760 may include one or more NFC account ceiling values 762, and a user action tracking module 764. Further, activity module 760 may be operable to determine that a usage value is within a threshold value of a NFC account ceiling value 762, and may providing a user with one or more actions to perform and information indicating how each of the one or more actions will affect the NFC account ceiling value 762. In an aspect, activity module 760 may obtain the NFC account ceiling value from a user interface 740. In an aspect, user action tracking module 764 may detect that the user has performed an action based on one or more informational values such as a measurement from detected from a user interface 740, one or more sensors 770, one or more applications 778, etc. In an aspect, the sensors 770 may optionally include any combination of a location sensor 772, an accelerometer 774, a gyroscope 776, a light sensor, one or more hardware components, one or more software components, one or more firmware components, etc. In an aspect, the actions may be associated with one or more applications 778 on the communications device 700. For example, an action may include a number of pages read, time spend reading, etc., using an e-reader application 778. In another example, an action may include a distance, a number of calories, a time, etc. associated with use of a sport activity tracking application 778. In another example, an action may include checking in at a location (e.g., a gym, a library, a school, etc.) based on measurements obtained from one or more sensors (e.g., a location sensor 772). In an aspect, activity module 760 may be operable to modifying the NFC account ceiling value 762 based on information user action tracking module 764 may provide indicating how the action will affect the NFC account ceiling value 762. Further, activity module 760 may prohibit the communications device 700 from performing the determined NFC action upon a determination that the user is attempting to perform a NFC action that will result in the NFC account ceiling value 762 being exceeded. In another aspect, activity module 760 may be operable to perform processes described with respect to FIGS. 5 and 6.

Additionally, communications device 700 may include user interface 740. User interface 740 may include input mechanisms 742 for generating inputs into communications device 700, and output mechanism 744 for generating information for consumption by the user of the communications device 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, the output mechanism 744 may include a display operable to present media content that is in image or video format or an audio speaker to present media content that is in an audio format.

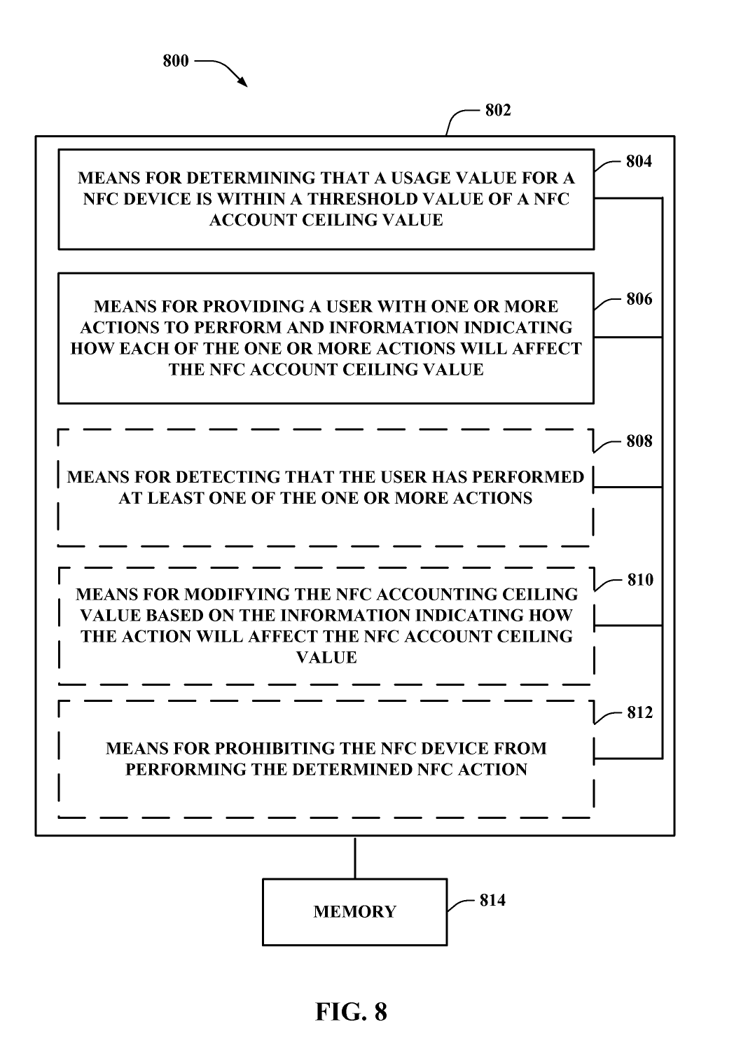

FIG. 8 depicts another depicts a block diagram of an exemplary communication system 800 operable to provide an incentive structure associated with various actions that may be tied to access and/or use of a NFC based payment form, according to an aspect. For example, system 800 can reside at least partially within a communications device (e.g., communications device 700). It is to be appreciated that system 800 is represented as including functional blocks, which can be functional blocks that represent functions implemented by a processor, software, or combination thereof (e.g., firmware). System 800 includes a logical grouping 802 of electrical components that can act in conjunction.

For instance, logical grouping 802 can include an electrical component that may provide means for determining that a usage value for a NFC device is within a threshold value of a NFC account ceiling value 804. In an aspect, the NFC account ceiling value may includes one or more ceiling values associated with one or more types of NFC enabled actions. In another aspect, the NFC account ceiling value may be associated with funding available through one or more accounts associated with the user. In such an aspect, the accounts may include a credit card account, a bank account, etc. In an aspect, the means for determining may further include means for determining that a user is attempting to perform a NFC action that will result in the NFC account ceiling value being exceeded.

Further, logical grouping 802 can include an electrical component that may provide means for providing a user with one or more actions to perform and information indicating how each of the one or more actions will affect the NFC account ceiling value 806. In an aspect, the actions may be associated with one or more applications on the NFC device. For example, an action may include a number of pages read, time spend reading, etc., using an e-reader application. In another example, an action may include a distance, a number of calories, a time, etc. associated with use of a sport activity tracking application. In another example, an action may include checking in at a location (e.g., a gym, a library, a school, etc.) based on measurements obtained from one or more sensors (e.g., a GPS monitor).

In an optional aspect, logical grouping 802 can include an electrical component that may provide means for detecting that a user has performed at least one of the one or more actions 808. In an aspect, the means for detecting 808 may include means for detecting based on information obtained from a user interface, an application, a location sensor, a gyroscope, an accelerometer, a light sensor, an auditory sensor, hardware, software, firmware, etc. For example, one or more applications and/or sensors associated with the NFC device may make various measurements and/or information available for other applications, etc., to use to detect performance of such actions.

In another optional aspect, logical grouping 802 can include an electrical component that may provide means for modifying the NFC account ceiling value based on the information indicating how the action will affect the NFC account ceiling value 810. In an aspect, the means for modifying may include means for increasing the NFC account ceiling value. For example, completion of a number of pages (based on information made available by an e-reader application) may raise the NFC account ceiling value. In another aspect, the means for modifying may include means for decreasing the NFC account ceiling value. For example, where a NFC device determines that a user has not checked-in at a library during a defined afterschool window, the NFC account ceiling value may be decreased.

In another optional aspect, logical grouping 802 can include an electrical component that may provide means for prohibiting the NFC device from performing the determined NFC action 812. For example, where a NFC account ceiling allocated for restaurant food purchases has been met, and the user has not performed any of the suggestions actions, then the NFC device may prohibit the user from using the NFC device to purchase food at a restaurant.

Additionally, system 800 can include a memory 814 that retains instructions for executing functions associated with the electrical components 804, 806, 808, 810 and 812, stores data used or obtained by the electrical components 804, 806, 808, 810, 812, etc. While shown as being external to memory 814, it is to be understood that one or more of the electrical components 804, 806, 808, 810 and 812 may exist within memory 814. In one example, electrical components 804, 806, 808, 810 and 812 can include at least one processor, or each electrical component 804, 806, 808, 810 and 812 can be a corresponding module of at least one processor. Moreover, in an additional or alternative example, electrical components 804, 806, 808, 810 and 812 may be a computer program product including a computer readable medium, where each electrical component 804, 806, 808, 810 and 812 may be corresponding code.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, mobile equipment (ME), remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH, near-field communications (NFC-A, NFC-B, NFC-f, etc.), and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method of wireless communications, comprising:
determining that a usage value for a near field communication (NFC) device is within a threshold value of a NFC account ceiling value; and
providing a user with one or more actions to perform and information indicating how each of the one or more actions will affect the NFC account ceiling value.

2. The method of claim 1, further comprising:
obtaining the NFC account ceiling value from a user input.

3. The method of claim 1, wherein the NFC account ceiling value includes one or more ceiling values associated with one or more types of NFC enabled actions.

4. The method of claim 1, further comprising:
detecting that a user has performed at least one of the one or more actions;
modifying the NFC account ceiling value based on the information indicating how the action will affect the NFC account ceiling value.

5. The method of claim 4, wherein the modifying further comprises increasing the NFC account ceiling value.

6. The method of claim 4, wherein the modifying further comprises decreasing the NFC account ceiling value.

7. The method of claim 4, wherein the detecting further comprises detecting based on information obtained from at least one of:
a user interface;
an application;
a location sensor;
a gyroscope;
an accelerometer;
a light sensor; or
an auditory sensor.

8. The method of claim 1, wherein the determining further comprises determining that the user is attempting to perform a NFC action that will result in the NFC account ceiling value being exceeded; and further comprising:
prohibiting the NFC device from performing the determined NFC action.

9. The method of claim 1, wherein the NFC account ceiling value is associated with funding available through one or more accounts associated with the user.

10. The method of claim 9, wherein the one or more accounts include at least one of a credit card account, or a bank account.

11. A computer program product, comprising:
a computer-readable medium comprising code for:
determining that a usage value for a near field communication (NFC) device is within a threshold value of a NFC account ceiling value; and
providing a user with one or more actions to perform and information indicating how each of the one or more actions will affect the NFC account ceiling value.

12. The computer program product of claim 11, wherein the computer readable medium further comprises code for:
obtaining the NFC account ceiling value from a user input.

13. The computer program product of claim 11, wherein the NFC account ceiling value includes one or more ceiling values associated with one or more types of NFC enabled actions.

14. The computer program product of claim 11, wherein the computer readable medium further comprises code for:
detecting that a user has performed at least one of the one or more actions;
modifying the NFC account ceiling value based on the information indicating how the action will affect the NFC account ceiling value.

15. The computer program product of claim 14, wherein the code for modifying further comprises code for increasing the NFC account ceiling value.

16. The computer program product of claim 14, wherein the code for modifying further comprises code for decreasing the NFC account ceiling value.

17. The computer program product of claim 14, wherein the detecting further comprises detecting based on information obtained from at least one of:
a user interface;
an application;
a location sensor;
a gyroscope;
an accelerometer;
a light sensor; or
an auditory sensor.

18. The computer program product of claim 11, wherein the computer readable medium further comprises code for:
determining that the user is attempting to perform a NFC action that will result in the NFC account ceiling value being exceeded; and
prohibiting the NFC device from performing the determined NFC action.

19. The computer program product of claim 11, wherein the NFC account ceiling value is associated with funding available through one or more accounts associated with the user.

20. The computer program product of claim 19, wherein the one or more accounts include at least one of a credit card account, or a bank account.

21. An apparatus for communications, comprising:
means for determining that a usage value for a near field communication (NFC) device is within a threshold value of a NFC account ceiling value; and
means for providing a user with one or more actions to perform and information indicating how each of the one or more actions will affect the NFC account ceiling value.

22. The apparatus of claim 21, further comprising:
means for obtaining the NFC account ceiling value from a user input.

23. The apparatus of claim 21, wherein the NFC account ceiling value includes one or more ceiling values associated with one or more types of NFC enabled actions.

24. The apparatus of claim 21, further comprising:
means for detecting that a user has performed at least one of the one or more actions; and
means for modifying the NFC account ceiling value based on the information indicating how the action will affect the NFC account ceiling value.

25. The apparatus of claim 24, wherein the means for modifying further comprises means for increasing the NFC account ceiling value.

26. The apparatus of claim 24, wherein the means for modifying further comprises means for decreasing the NFC account ceiling value.

27. The apparatus of claim 24, wherein the means for detecting further comprises means for detecting based on information obtained from at least one of:
a user interface;
an application;
a location sensor;
a gyroscope;
an accelerometer;
a light sensor; or
an auditory sensor.

28. The apparatus of claim 21, wherein the means for determining further comprises means for determining that the user is attempting to perform a NFC action that will result in the NFC account ceiling value being exceeded; and further comprising:
means for prohibiting the NFC device from performing the determined NFC action.

29. The method of claim 21, wherein the NFC account ceiling value is associated with funding available through one or more accounts associated with the user.

30. The method of claim 29, wherein the one or more accounts include at least one of a credit card account, or a bank account.

31. An NFC device for communications, comprising:
one or more applications;
a memory;
a processor coupled to the memory; and
an activity module coupled to at least one of the memory, the processor, or the one or more applications, and configured to:
determine that a usage value for a near field communication (NFC) device is within a threshold value of a NFC account ceiling value; and
provide a user with one or more actions to perform and information indicating how each of the one or more actions will affect the NFC account ceiling value.

32. The apparatus of claim 31, wherein the activity module is further configured to:
obtain the NFC account ceiling value from a user input.

33. The apparatus of claim 31, wherein the NFC account ceiling value includes one or more ceiling values associated with one or more types of NFC enabled actions.

34. The apparatus of claim 31, wherein the activity module is further configured to:
detect that a user has performed at least one of the one or more actions; and
modify the NFC account ceiling value based on the information indicating how the action will affect the NFC account ceiling value.

35. The apparatus of claim 34, wherein the activity module is further configured to increase the NFC account ceiling value.

36. The apparatus of claim 34, wherein the activity module is further configured to decrease the NFC account ceiling value.

37. The apparatus of claim 34, wherein the activity module is further configured to detect based on information obtained from at least one of:
a user interface;
the one or more applications;
a location sensor;
a gyroscope;
an accelerometer;
a light sensor; or
an auditory sensor.

38. The apparatus of claim 31, wherein the activity module is further configured to:
determine that the user is attempting to perform a NFC action that will result in the NFC account ceiling value being exceeded; and
prohibit the NFC device from performing the determined NFC action.

39. The apparatus of claim 31, wherein the NFC account ceiling value is associated with funding available through one or more accounts associated with the user.

40. The apparatus of claim 39, wherein the one or more accounts include at least one of a credit card account, or a bank account.
